(19) United States
(12) Patent Application Publication
(10) Pub. No.: US 2019/0053973 A1
(43) Pub. Date: Feb. 21, 2019

(54) PORTABLE FOAM ROLLER AND SITTING PAD SYSTEM

(71) Applicant: Devon de Balasi Brown, Vancouver (CA)

(72) Inventor: Devon de Balasi Brown, Vancouver (CA)

(21) Appl. No.: 15/682,193

(22) Filed: Aug. 21, 2017

(51) Int. Cl. A61H 15/00; A63B 21/00

(52) U.S. Cl. CPC A61H 15/0092; A61H 2201/1695; A61H 2015/0014; A63B 21/4039

(57) ABSTRACT

A portable foam roller and sitting pad system including a bottle having a generally cylindrical body, and a flexible foam pad configured to be secured around the bottle creating a therapeutic foam rolling device. The flexible foam pad further provides a sitting pad for a user when unsecured from the bottle.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of exercise and mobility products and more specifically relates to a portable foam roller and sitting pad system.

### 2. Description of Related Art

Foam rollers have become an important piece of equipment in the field of exercise and mobility. Use of a foam roller provides numerous benefits to its user through myofascial release during warm-up and recovery. A foam roller also can be used in warm up and recovery. Currently foam rollers are bulky and large in size, causing portability problems for hikers, travelers and others. Typically, a user's bag is typically ‘full’ and carrying around an oversized foam roller is not desirable. A suitable solution is needed.

U.S. Pub. No. 2015/0073321 to Lani Taylor relates to a self-massage roller and bottle. The described self-massage roller and bottle includes a self-massage roller having a bottle, a covering, and, optionally, a removable cap. The bottle provides a vessel for holding liquids. The covering includes a base layer and a plurality of nubs. The base layer overlays the outer surface of the bottle. Each nub in the plurality of nubs protrudes from the base layer in a direction radially away from the outer surface of the bottle. Each nub is a massage element, and the plurality of nubs forms a textured surface for myofascial release of certain muscles of the user. In another version, each nub is attached directly to the outer surface of the bottle without an intervening base layer. In versions with a cap, the cap may include a flip-up spout, or it may have a plunger valve that opens upon pulling the plunger outward and closes upon pushing in the plunger.

### BRIEF SUMMARY OF THE INVENTION

In view of the foregoing disadvantages inherent in the known exercise and mobility products art, the present disclosure provides a novel sitting pad and foam roller system when used in combination with an appropriate bottle. The general purpose of the present disclosure, which will be described subsequently in greater detail, is to provide a sitting pad that can also convert a standard water bottle into a foam roller when used in combination.

A portable foam roller and sitting pad system is disclosed herein. The portable foam roller and sitting pad system includes a bottle having a generally cylindrical body defined by an outer surface, a lid, and a base, a flexible foam pad comprising a thickness having at least one fastener and a plurality of securing-strips configured to secure the flexible foam pad around the bottle about the outer surface creating a therapeutic foam rolling device. The securing-strips comprising tacky compound may create added friction. The flexible foam pad is substantially planar. The flexible foam pad may comprise a smooth or textured top-surface which may include ribs or other suitable textures for providing massaging means. The flexible foam pad further provides a sitting pad for a user when unsecured from the bottle. The present design provides that while in sitting pad mode the device has the capability to fold-out making it so it can be larger in size.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a portable foam roller and sitting pad system, constructed and operative according to the teachings of the present disclosure.

FIG. 1A is a perspective view of the portable foam roller and sitting pad system during an ‘in-use’ condition, according to an embodiment of the disclosure.

FIG. 1B is a perspective view of the portable foam roller and sitting pad system during an ‘in-use’ condition, according to an embodiment of the disclosure.

FIG. 2 is a perspective view of the portable foam roller and sitting pad system of FIG. 1, according to an embodiment of the present disclosure.

FIG. 3 is a perspective view of the portable foam roller and sitting pad system of FIG. 1, according to an embodiment of the present disclosure.

FIG. 4 is a perspective view of the portable foam roller and sitting pad system of FIG. 1, according to an embodiment of the present disclosure.

FIG. 5 is a perspective view of a kit of the portable foam roller and sitting pad system of FIG. 1, according to an embodiment of the present disclosure.

FIG. 6 is a perspective view of a kit of the portable foam roller and sitting pad system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to exercise and mobility products and more particularly to a portable foam roller and sitting pad system as used to improve the convenience providing a sitting pad, foam roller and water bottle combination.

Generally, the present invention is a portable massage roller which may also be used as a sitting pad. A user may transform a standard 1 L bottle or other sized bottle into a therapeutic foam roller, without compromising space or weight. The flexible foam pad may be stored in a flat position or fold-up configuration for easy packing and use as a sitting pad. The device further includes tacky/rubber strips to stop the bottle from slipping out when in roller mode and fasteners on sides of the flexible foam pad lock the flexible foam pad around the bottle. The flexible foam pad is further configured to fold up or fold out for storage. The flexible foam pad may include creases allowing for the device to fold in an accordion-like style. The folded flexible foam pad may then be stored or used as a pillow. The device may be used in fitness, rehab and physiotherapy circles.

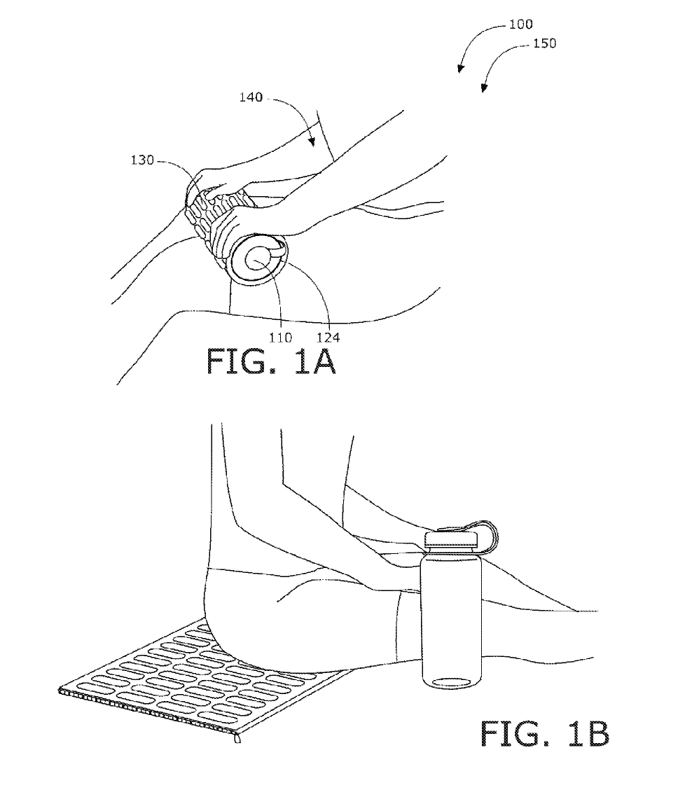

Referring now more specifically to the drawings by numerals of reference, there is shown in FIGS. 1A-6, various views of a portable foam roller and sitting pad system 100. FIG. 1A-1B shows a portable foam roller and sitting pad system 100 during an ‘in-use’ condition 150, according to an embodiment of the present disclosure. As illustrated, the portable foam roller and sitting pad system 100 may include a bottle 110 having a generally cylindrical body 120 defined by an outer surface 122, a lid 124, and a base 126, and a flexible foam pad 130 comprising a thickness 132 having at least one fastener 160 and a plurality of securing-strips 166 configured to secure the flexible foam pad 130 around the bottle 110 about the outer surface 122 creating a therapeutic foam rolling device.

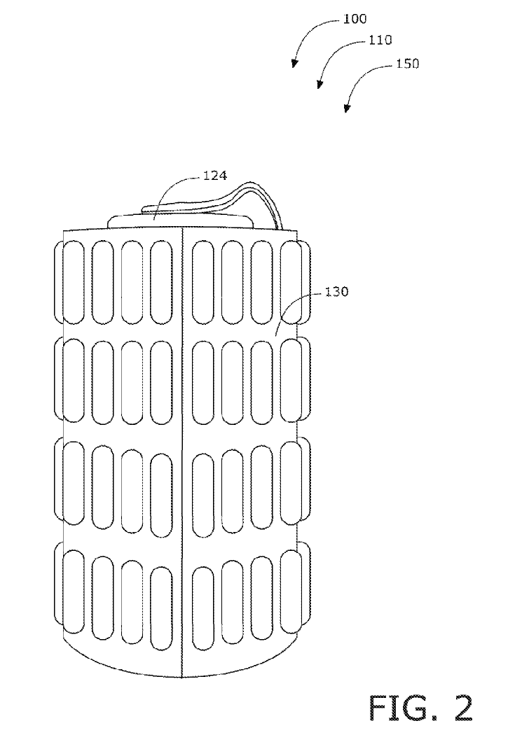

FIG. 2 shows a perspective view of the portable foam roller and sitting pad system 100 of FIG. 1, according to an embodiment of the present disclosure. As above, the portable foam roller and sitting pad system 100 may include the bottle, and the flexible foam pad 130 which when combined may provide a therapeutic foam rolling device. The flexible foam pad 130 is substantially planar. The flexible foam pad 130 may comprise a smooth or textured top-surface which may include ribs or other suitable textures for providing massaging means (may be ribbed or smooth in alternate embodiments). The plurality of securing-strips 166 are located on a bottom-surface of the flexible foam pad 130, the bottom-surface in contact with the bottle 110 when installed. The plurality of securing-strips 166 preferably comprise rubber for securing the flexible foam pad 130 around the bottle 110 about the outer surface 122.

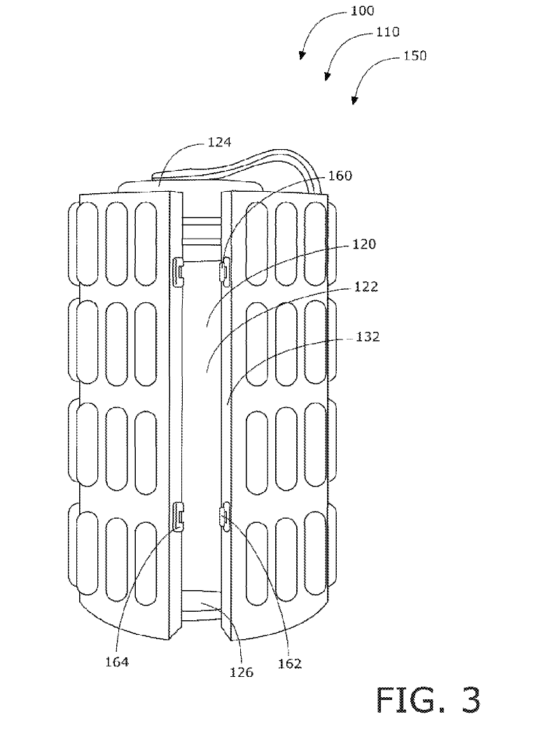

FIG. 3 shows a perspective view of the portable foam roller and sitting pad system 100 of FIG. 1, according to an embodiment of the present disclosure. As above, the portable foam roller and sitting pad system 100 may include the bottle, and the flexible foam pad 130 in functional combination. The bottle 110 may comprise a 1-liter water bottle or other suitable sized water bottle. The at least one fastener 160 may comprise slide-and-lock snaps, zipper fasteners, buckles, or other suitable fastening means. The at least one fastener 160 may include a male-fastener 162 and a female-fastener 164. The male-fastener 162 and the female-fastener 164 are located on opposing sides of the flexible foam pad 130 along the thickness 132. The male-fastener 162 and the female-fastener 164 when secured create a cylindrical profile of the flexible foam pad 130. In certain embodiments the fastening system may use an internal (through a tunnel in the foam) wire/strap that connects the male and female ends of the connection point. This feature, as designed, increases the strength of the connection point as adhering a buckle/snap to the foam may prove difficult in some manufactures.

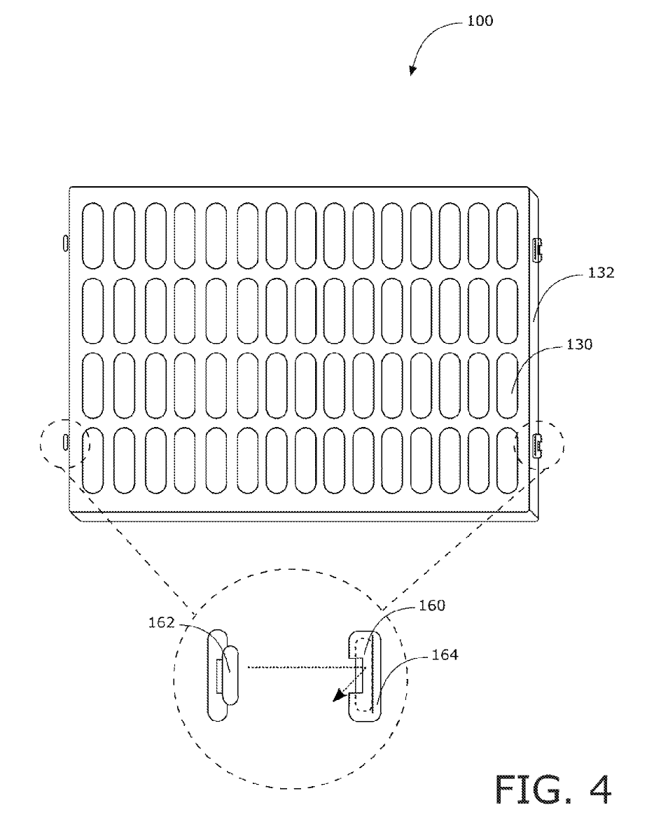

FIG. 4 shows a perspective view of the portable foam roller and sitting pad system 100 of FIG. 1, according to an embodiment of the present disclosure. As above, the portable foam roller and sitting pad system 100 may include a bottle 110 having a generally cylindrical body defined by an outer surface 122, a lid 124, and a base 126, a flexible foam pad 130 may comprise a thickness 132 having at least one fastener 160 and a plurality of securing-strips 166 configured to secure the flexible foam pad 130 around the bottle 110 about the outer surface 122 creating a therapeutic foam rolling device. The flexible foam pad 130 provides a sitting pad for a user 140 when unsecured from the bottle 110. The outer surface 122 is covered when the flexible foam pad 130 is secured around the bottle 110 and the base 126 and the lid 124 of the bottle 110 are exposed. The flexible foam pad 130 comprises a sleeve when secured around the bottle. The flexible foam pad 130 is substantially rectangular when in an unrolled-condition.

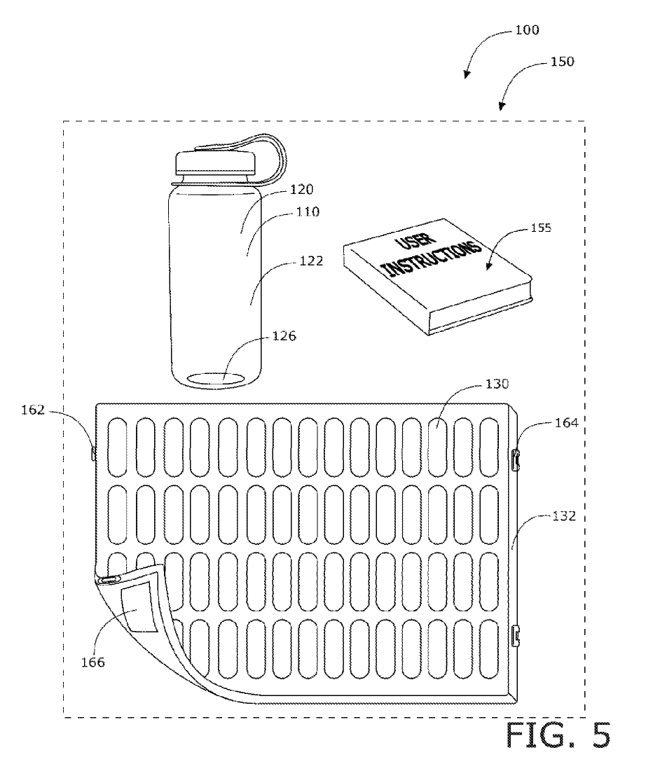

FIG. 5 shows a perspective view of the portable foam roller and sitting pad system 100 of FIG. 1, according to an embodiment of the present disclosure. As above, the portable foam roller and sitting pad system 100 may include a kit. The kit may include a bottle 110, a flexible foam pad 130, and a set of user instructions 155. The instructions may detail functional relationships in relation to the structure of the portable foam roller and sitting pad system 100 (such that the portable foam roller and sitting pad system 100 can be used, maintained, or the like, in a preferred manner).

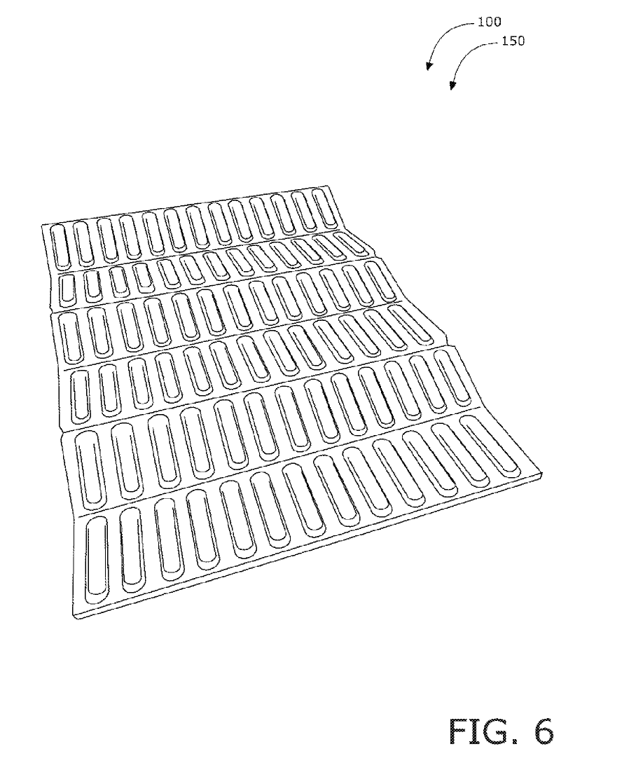

FIG. 6 shows a perspective view of the portable foam roller and sitting pad system 100 of FIG. 1, according to an embodiment of the present disclosure. As shown in FIG. 6, the flexible foam pad 130 may include creases allowing for the device to fold in an accordion-like style.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable foam roller and sitting pad system comprising:
a bottle having a generally cylindrical body defined by an outer surface, a lid, and a base; and
a flexible foam pad comprising a thickness having at least one fastener and a plurality of securing-strips configured to secure said flexible foam pad around said bottle about said outer surface creating a therapeutic foam rolling device.

2. The portable foam roller and sitting pad system of claim 1, wherein said flexible foam pad is substantially planar.

3. The portable foam roller and sitting pad system of claim 1, wherein said flexible foam pad comprises a textured top-surface.

4. The portable foam roller and sitting pad system of claim 1, wherein said plurality of securing-strips are located on a bottom-surface of said flexible foam pad, said bottom-surface in contact with said bottle when installed.

5. The portable foam roller and sitting pad system of claim 1, wherein said plurality of securing-strips comprise rubber for securing said flexible foam pad around said bottle about said outer surface and avoiding said bottle slipping out from said flexible foam pad.

6. The portable foam roller and sitting pad system of claim 1, wherein said bottle comprises a length and width configured to be encircled by said flexible foam pad.

7. The portable foam roller and sitting pad system of claim 1, wherein said flexible foam pad is configured to fold up and fold out.

8. The portable foam roller and sitting pad system of claim 1, wherein said at least one fastener comprises a male-fastener and a female-fastener.

9. The portable foam roller and sitting pad system of claim 1, wherein said male-fastener and said female-fastener are located on opposing sides of said flexible foam pad along said thickness.

10. The portable foam roller and sitting pad system of claim 1, wherein said male-fastener and said female-fastener when secured create a cylindrical profile of said flexible foam pad.

11. The portable foam roller and sitting pad system of claim 1, wherein said at least one fastener is selected from a group consisting of buckles, zipper fasteners, and slide-and-lock snaps.

12. The portable foam roller and sitting pad system of claim 1, wherein said flexible foam pad provides a sitting pad for a user when unsecured from said bottle.

13. The portable foam roller and sitting pad system of claim 1, wherein said outer surface is covered when said flexible foam pad is secured around said bottle and said base and said lid of said bottle are exposed.

14. The portable foam roller and sitting pad system of claim 1, wherein said flexible foam pad comprises a sleeve when secured around said bottle.

15. The portable foam roller and sitting pad system of claim 1, wherein said flexible foam pad is substantially planar and rectangular when in an unrolled-condition.

16. The portable foam roller and sitting pad system of claim 1, wherein said flexible foam pad comprises a smooth said top-surface.

17. A portable foam roller and sitting pad system comprising:
a bottle having a generally cylindrical body defined by an outer surface, a lid, and a base;
a flexible foam pad comprising a thickness having at least one fastener and a plurality of securing-strips configured to secure said flexible foam pad around said bottle about said outer surface creating a therapeutic foam rolling device;
wherein said flexible foam pad is substantially planar;
wherein said plurality of securing-strips are located on a bottom-surface of said flexible foam pad, said bottom-surface in contact with said bottle when installed;
wherein said plurality of securing-strips comprise rubber for securing said flexible foam pad around said bottle about said outer surface;
wherein said bottle comprises a length and width configured to be encircled by said flexible foam pad;
wherein said at least one fastener comprises a male-fastener;
wherein said at least one fastener comprises a female-fastener;
wherein said male-fastener and said female-fastener are located on opposing sides of said flexible foam pad along said thickness;
wherein said male-fastener and said female-fastener when secured create a cylindrical profile of said flexible foam pad;
wherein said at least one fastener is selected from a group consisting of buckles, zipper fasteners, and slide-and-lock snaps;
wherein said flexible foam pad provides a sitting pad for a user when unsecured from said bottle;
wherein said outer surface is covered when said flexible foam pad is secured around said bottle and said base and said lid of said bottle are exposed;
wherein said flexible foam pad comprises a sleeve when secured around said bottle; and
wherein said flexible foam pad is substantially rectangular when in an unrolled-condition.

18. The portable foam roller and sitting pad system comprising a kit including:
a bottle;
a flexible foam pad; and
a set of user instructions.
